(19) United States
(12) Patent Application Publication
(10) Pub. No.: US 2003/0070752 A1
(43) Pub. Date: Apr. 17, 2003

(54) Method of manufacture for fluid handling barrier ribbon with polymeric tubes

(76) Inventors: Kevin Bergevin, Kingston (CA); Greg A. Campbell, Kingston (CA)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/255,247

(22) Filed: Sep. 26, 2002

Related U.S. Application Data
(60) Provisional application No. 60/325,223, filed on Sep. 27, 2001.

(51) Int. Cl. B32B 31/00

(52) U.S. Cl. 156/297; 428/188

(57) ABSTRACT

A method for making fluid handling structures, made by positioning multiple polymeric tubes spaced apart by at least 1½ tube diameters measured center-to-center on a sheet of foil made of metal, with plastic on at least the side facing the tubes, adding another such foil to bond on the other side thereof, and heating the resulting assembly, either before or after adding the second layer of foil, to bond it into a structure with spaced apart tubes encapsulated in foil on both sides.

### CROSS REFERENCE TO RELATED APPLICATION

This application claims the benefit of U.S. Provisional Application No. 60/325,223 filed Sep. 27, 2001.

### FIELD OF THE INVENTION

The invention relates to a method of manufacturing plastic tube fluid handling means such as for use in heat exchange and more particularly to such means with a metal barrier layer in the form of heat transfer ribbon.

### BACKGROUND OF THE INVENTION

Among the challenges in making plastic heat exchangers is the need for improved barrier properties. In some applications, such as air-air heat exchange, such as in a charge air cooler, permeability of the plastic tubes is not a problem. In other applications, permeability must be well managed. Among the highest demands for low permeability are refrigeration applications. There is a need to keep the refrigerant in and both water vapor or moisture and air out. Refrigerants are also under pressure, higher in condensers and lower in evaporators, adding to the need for good permeation control.

It has been recognized that metal layers will provide impermeability to polyamide tubes for use in heat exchangers. However, structures and procedures for obtaining good impermeability for practical use in refrigeration systems from the combination of metal and plastic or polyamide and aluminum are not available. Some have suggested applying metal after assembling a structure, such as by sputtering. However, sputtering, while it may give a complete coating, does not provide the impermeability needed. Also, thicker metal layers would permit improved heat transfer from the tubes to a web. Much of the art uses fins of aluminum brazed onto aluminum tubes perpendicular to the tubes to improve heat exchange, which is not readily done with plastic tubes.

Others have proposed a web between tubes, but no-one has yet developed an appropriate configuration of tubes and metal to obtain the needed impermeability, when the need for maximum heat transfer is also considered.

U.S. Pat. No. 4,069,811 discloses in FIG. 7 a heat exchanger element with spaced-apart copper or plastic tubes surrounded by and encased in spot-welded sheets of a rigid, preferably black, metal absorber plate. U.S. Pat. No. 5,469,915 shows tubes of plastic or metal encased in and held apart by plastic sheets. European Patent Publication 864,823 A2, published on Sep. 26, 1998, discloses tubes for solar heat exchangers made of an elastomer or plastic inner layer, a stiffener layer of thermally conductive metal such as aluminum in the form of a mesh or a helical layer, and optionally an outer layer of the same elastomer or plastic. The inner polymer layer can be 0.1-2.5 mm (0.004 inches to 0.1 inches) thick, preferably 0.1-0.3 mm (0.004 inches to 0.012 inches), and the stiffener can be 0.1-2 mm (0.004 inches to 0.079 inches) thick. However, although the metal stiffener may absorb heat well, it is taught to be used as a mesh or helical layer, so it would not provide any degree of impermeability.

U.S. Pat. No. 3,648,768 shows making a web of plastic with parallel tubes spaced apart in the web. It says nothing about barrier layers or using metal in the webs.

### SUMMARY OF THE INVENTION

The invention provides a method for making a fluid handling apparatus comprising a plurality of polymeric tubes arranged in parallel and placed at least 1½ tube diameters apart measured center-to-center, said tubes being surrounded by and sealed to a laminated foil, said foil having two faces, one facing toward the tubes, and the other facing away from the tubes, said foil comprising at least one layer of metal with at least one polymer layer on at least the side facing the tubes,

said tubes having an inner diameter in the range of 0.5-4 mm and a wall thickness in the range of 0.05-0.3 mm,

said foil having a total thickness in the range of 0.05-0.25 mm and metal thickness in the range of 0.002-0.1 mm,

said method comprising the steps of

contacting the tubes on one side with a first foil, contacting the tubes on the other side of the tubes with a second foil,

heating the tubes with the foil on at least one side to adhere the foil to the tubes before or after contacting the tubes with said second foil,

conforming said first and second foils to the tubes to essentially eliminate air bubbles or gaps,

and optionally completing the heat sealing of both the first and second foils to the tubes with a second heating step.

Preferably, from 5 to 20 tubes are used in the structure, and preferably the inside diameter of the tubes is 1 to 3 mm.

Such a structure is herein referred to as a barrier ribbon. Reference is made throughout the case to “tubes”, “tubing”, and the like. It is to be understood that these terms are often used interchangeably and it will be apparent to the reader that in some cases either term could apply. Moreover, those having skill in the art to which the invention pertains will recognize that throughout the description the terms “foil”, “laminated foil”, and “film” and the like are intended to convey the same meaning.

### BRIEF DESCRIPTION OF THE DRAWINGS

FIG. 1 is an illustration of the structure of the invention in perspective.

FIG. 2 is a detailed end view of a cross section of a typical structure of the invention.

FIG. 3(a) is a side view of apparatus used in the method of manufacture of polymeric barrier tubes according to the invention.

FIG. 3(b) is a cross-sectional view of a hot plate and jig used in FIG. 3(a) and product formed therefrom.

FIG. 3(c) is a cross-sectional view of a product of FIG. 3(a), shown prior to its full conversion to the final product.

FIG. 4(a) is a side view of further apparatus used in the method of manufacture of polymeric barrier tubes according to the invention.

FIG. 4(b) is a cross-sectional view of a die plate and weight configuration used in FIG. 4(a).

FIG. 4(c) is a plan view of a die plate used in FIGS. 4(a) and 4(b).

### DETAILED DESCRIPTION OF THE INVENTION

Typically an evaporator in a refrigeration or air conditioning system consists of a number of finned metal tubes, the tubes having a greater internal diameter than the liquid refrigerant inlet tubes, to allow for expansion and cooling, and having a specified length to allow for complete evaporation to the gaseous phase. Condensers are configured in an analogous manner, but usually must operate at higher pressures to effect conversion of the gaseous refrigerant to a liquid phase. When attempting to design a refrigerant-capable exchanger from polymeric tubing, a number of factors must be considered:

i) The refrigerant must be retained inside the tubing structure for a long time such as for many years, with minimal losses.

ii) Moisture and air must be prevented from permeating into the tubing. Air is non-condensable and would diminish the performance of the heat exchanger. Moisture reacts with refrigerants such as hydrofluorocarbons (HFC's) and hydrochlorofluorocarbons (HCFC's) and the products of this reaction can lead to failure of the system due to corrosion and sludge.

iii) Many refrigerants operate under high pressures (several hundred psig) and the tubing must be capable of withstanding 3-5 times the normal system operating pressures.

Previous work has shown that lengths of co-extruded tubing 3-9 m (10-30 feet) long, formed into coiled structures of closely-spaced tubing, with suitable end connections, can transfer heat between refrigerant and air streams. Unfortunately, the best polymeric barrier materials available may at times be insufficient to keep moisture and air entry below an acceptable level.

In heat exchangers comprised of plastic tubing, typically all of the heat transfer area is primary surface or wetted surface, owing to the low thermal conductivity of plastics. Secondary heat transfer surfaces such as transverse fins are generally of little use and not used.

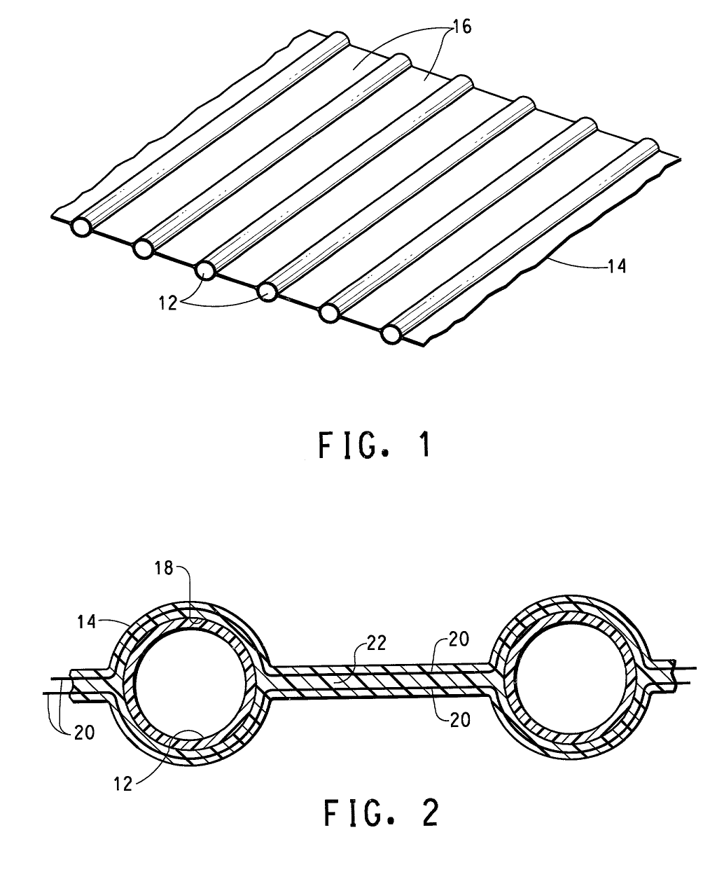

Having reference to FIG. 1, the present invention contemplates a composite structure in which an array of polymeric tubes 12 is completely surrounded by a thermally conductive film 14. Instead of the polymeric tubes 12 being in close proximity, they are spaced farther apart, with generally at least about one and one-half tube diameter spacing (measured center-to-center) between each pair of tubes 12, and are connected by a webbing 16 of thermally conductive film between each tube 12. The thermally conductive webbing 16 serves as a secondary heat transfer surface and reduces the quantity of tubing required in the construction, consistent with other needs, such as the need for low pressure drop.

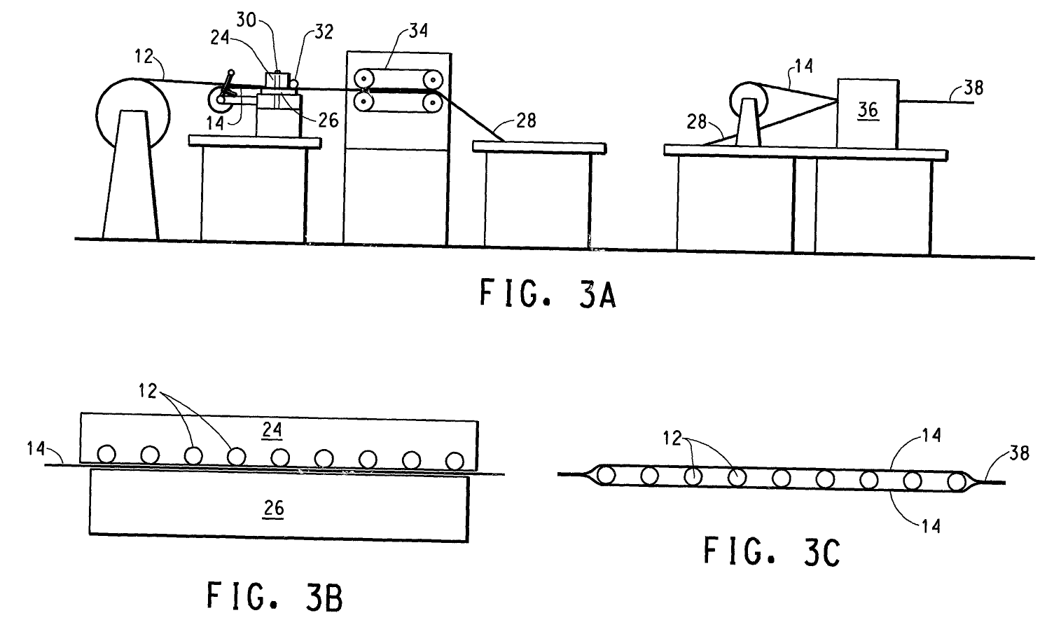

As shown in FIG. 2, the thermally conductive film 14 is wrapped in conformal fashion around the tubes 12 in the array and is preferably bonded to the outer surface 18 of the tubes 12 where it contacts the tubes 12 or to itself in the areas adjacent to the tubes 12. It is desirable to produce a tight wrap around the tubes 12, with no significant free volume between the outside surface 18 of the tubes 12 and the inside surface of the film 14 in order to maximize heat transfer performance.

In particular, when film containing a metal layer 20 consists of a laminate of a metal (e.g. aluminum), such as aluminum with polymeric layers 22, then the metal layer 20 provides a suitable barrier, capable of preventing excessive moisture and air entry. Such foil laminates are widely available and are of relatively low cost, compared with other materials of similar barrier properties, such as those containing multiple inorganic layers applied by plasma deposition processes.

Furthermore, the location of the high barrier layer outside of, and surrounding the tubing, as shown in FIGS. 1 and 2, serves to keep the tubing relatively dry. This is significant when the tubing is a moisture sensitive material such as a polyamide. The burst pressure of dry polyamide tubing is much higher than it is for polyamide exposed to environmental humidity. This feature allows the tubing to be designed with a larger tube diameter, and this further enables a reduction in the number of tubes, thus lowering cost without resulting in excessive tube-side pressure drop. As is known in the art, pressure drops are measured in heat exchangers both on the tube side, meaning inside the tubes, and on the air side, meaning outside the tubes.

While attention has been devoted to the use of polyamides as a useful polymer, it is to be appreciated that any number of polymeric materials may be selected for use in the method described herein. These include without limitation, polyesters and polyolefins.

The combination of all of these features results in a relatively simple low cost material, a structure of a number of polyamide tubes with outer bonding layer inside a foil laminate with inner bonding layer, which could be produced in a low cost process and which would be fully functional as a heat exchanger material for a wide variety of refrigerant-air and possibly other exchangers.

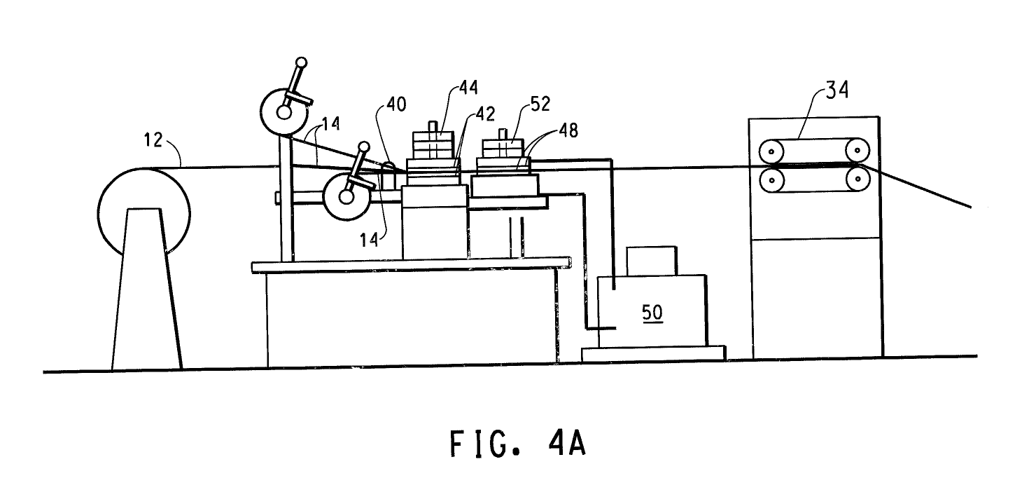

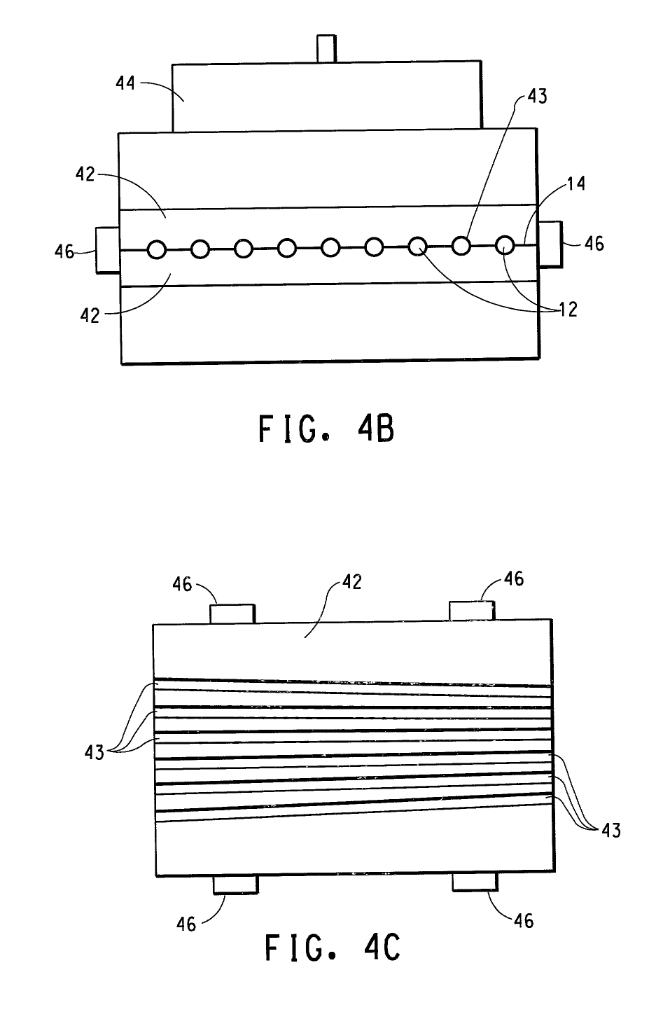

Having reference to FIGS. 3(a) and 3(b) and 3(c) and 4(a) and 4(b) and 4(c), the method for manufacture of fluid handling polymeric barrier tubes as described above can be described as follows.

In FIG. 3(a) tubes 12 are pulled through jig 24 which rests on top of hot plate 26. Simultaneously, and at the same speed, film 14 is pulled between the tubes 12 and the hot plate 26. The surface of the tubes 12 contacts the surface of the film 14 on the hot plate 26, as shown in more detail in FIG. 3(b). Heat from the hot plate bonds the tubes 12 to the film 14 to produce the tack-welded structure 28. Pressure for bonding the tubes 12 to the film 14 is supplied by the weight 30 and lay-on roller 32. The belt puller 34 provides the motive power to pull the materials through this first step. In the second step, the tack-welded structure 28 is fed into rotary edge sealer 36 along with a second film layer 14. The rotary edge sealer 36 heat-seals the edges to produce ribbon sleeve 38, which is shown in more detail in FIG. 3(c). The ribbon sleeve 38 is then placed in a vacuum sealer in the third step (not shown) which removes the air from between the tubes and the films and seals the end, as is commonly practiced in the making of vacuum pouches. In the fourth step (not shown) the ribbon sleeve is placed in a hot oven and the bonding is completed.

An alternative apparatus is shown in FIG. 4(a). Tubes 12 are pulled together with two films 14 through guides 40 and then between two matching heated die plates 42. The heated die plates have semi-circular grooves 43 in them. The pattern of grooves 43 is converging, such that the spacing between the grooves at the entry end of the plates is larger than it is at the exit end of the plates, as shown in more detail in FIG. 4(c). Weight 44 on top of the die plates provides the means for applying pressure. The plates may be aligned by means of alignment tabs 46. The films 14 and tubes 12 are then pulled through a matching set of grooved cooling plates 48 in which the grooves are parallel. The cooling plates are cooled by means of circulating cold water supplied by chiller system 50. A weight 52 is located on top of the cooling plates in order to apply pressure to the ribbon. The belt puller 34 pulls the materials through the process to yield the ribbon. The ribbon may then optionally be slit into single tube or multiple tube structures as required.

In addition, the relatively large spacing between tubes would allow the barrier ribbon to be slit as needed, possibly at the ends to facilitate joining operations, or elsewhere to facilitate water drainage, etc.

Corrosion of the metallic layer can be minimized with the inclusion of a polymeric layer outside of the metallic layer, i.e. the metallic layer is sandwiched. Alternatively, for more corrosive applications, a more corrosion resistant metal such as nickel or tin may be used as the metallic layer. Aluminum here means the metal itself or various appropriate alloys based on aluminum.

It will be appreciated that any number of configurations for the metal and foil can be selected, depending on the design of interest. For example, two or more layers of foil can be used, and they may be made from a single sheet that has been folded, or from multiple sheets, with the plastic layers applied to each layer of metal or to the whole set of foil. Alternatively, when a first layer of foil is applied to one side of a tube or set of tubes, and then a second layer is applied to the other side, the same piece of foil can be folded and used on both sides.

For some applications, it may be desirable for the film containing a metal layer to be quite flexible, so that the entire bonded structure may be formed into a coil shape. Also, the barrier ribbon could be rolled up transversely and placed inside a larger pipe to form a coaxial heat exchanger, with the tubes running substantially parallel to the outer pipe. Heat exchangers made from barrier ribbon are lighter in weight than existing all-metal exchangers.

Barrier ribbon material could be produced in large sections and cut into strips of desired width and length for making coils. Potentially less labor intensive processes may be used for the manufacture of heat exchangers, compared with the processes for making traditional all-metal exchangers.

Traditional metal fins are easily bent and damaged, affecting air flow. Elastic limits of aluminum fins are easily exceeded and they suffer plastic deformation, staying out of shape once they are bent. This also makes cleaning difficult. Barrier ribbons of the invention are primarily polymeric and flexible and behave with much greater elasticity or spring back and are reinforced by the tubing embedded within the ribbon.

Coils made by winding lengths of ribbon around a central core can be circular in shape, or they can be in other shapes such as oval, etc., and the width of the ribbon can be varied, in order to optimize heat transfer and air side pressure drop.

Simple spacer elements can be designed to separate layers of the ribbon within the coil, in order to maintain the desired spacing between the layers.

Heat exchangers may also be constructed in other shapes, i.e. ribbons may be straight rather than coiled or wound. By staggering or offsetting successive layers of ribbon a pathway for the air is created as it flows through the ribbon coil between the layers of ribbon. In this case, the tubes embedded in the ribbon serve to increase the turbulence of the air flow across the ribbon.

One disadvantage of current metal heat exchangers is the relatively large tubes which block air flow. In the present case the structure comprises a multiplicity of much smaller tubes which are embedded in the fins. The spacing between successive layers of the ribbon can be varied, in order to optimize heat transfer and air side pressure drop.

The tube spacing within the ribbon can be varied, and can either be uniform or can vary across the ribbon. Tubes can be circular in cross-section or can be elliptical or of other non-circular shape. The tubing may be extruded as elliptical in shape or may be extruded as circular in shape and then made elliptical in the process of making the ribbon.

It is to be understood that the basic ribbon design may be modified by punching holes or slits or forming louvers in the film layers, as long as the integrity of the tubing isn't compromised, in order to increase air turbulence or to facilitate water or condensate drainage.

A number of different polymers could be chosen for the tubing material, but selection depends on the needs for specific applications and should be based largely on service temperature, chemical resistance and pressure.

Tube diameter and wall thickness are sized to handle the pressure of desired refrigerants. For example dry nylon 66 tubing, of 2 mm (0.079 inches) OD and 0.18 mm (0.007 inches) wall thickness will burst at pressures >140 bar (>2000 psi) and is desirable for high pressure applications, and the nylon can be kept dry by the barrier layer.

One may optionally co-extrude layers on the exterior of tubing, or add layers on one side of the film material to enhance bonding. It is important in some cases to bond the film layer to the tubing and to the opposing film layer in order to minimize resistance to heat transfer and to prevent pocketing of refrigerant between the tubing and the foil laminate.

Metal surrounds the tubing except in small areas at nodes and edges and this provides a significant improvement in barrier to permeation of refrigerant, moisture and air. The thermal conductivity of aluminum is high and tube-to-tube distances are typically small, so only a thin layer is required, in order for it to function as an extended heat transfer surface. Within the foil laminate, more than one layer of metal could be used or the metal layer thickness could be varied to achieve desired levels of barrier or heat transfer.

The number of parallel tubing circuits can be varied to bring tube-side pressure drop within the desired range. The tube ends of the barrier ribbons can be joined into larger plastic or metal pipes, such as by encapsulating them with a thermoset or thermoplastic or by melt bonding the tube ends into a small plastic tube sheet.

In order for the barrier ribbon to be useful in the construction of low-cost heat exchangers, it is important that a suitable low-cost process be identified for making the barrier ribbon. Early on it was realized that the tubes could be tacked onto one of the film layers by applying heat and pressure. Though the tubes were only bonded to the film over a very narrow area, the bond was sufficient to hold the tubes in place long enough to allow the process to be completed. It was necessary to have some means to line up the tubing and this was accomplished by pulling the tubing through a block of polytetrafluoroethylene (PTFE) which had slots in it. The slots expose part of the tube surface to the outside. By pulling the film and the aligned tubes, in contact, over a heat source, the tacking of the tubes to the film was achieved. The process was completed by sealing the edges of a second film to the first film and then evacuating all of the air which was between the tubes and the film, using a vacuum sealer. When the structure was then placed in an oven of suitable temperature, the final bonding together of all layers was completed using atmospheric pressure as the source of pressure.

The vacuum/thermal lamination process referenced in FIGS. 3(a)-(c) and Examples 1-2 herein and used to make samples of barrier ribbon can be scaled up and refined, but the process does have some inherent limitations, namely:

i) The drawing of a high vacuum inside the structure appears to require a non-continuous process, where the material must be cut into discrete lengths. A continuous process, with less handling, may be preferred.

ii) The final heat sealing step is carried out on unconstrained film, so that the residual stresses in the film cause the film to shrink at or near its melting point. Since the metallic layer is unable to shrink, the result is a series of small transverse wrinkles in the finished product.

To deal with the first issue, one could conceive of a process where the ribbon is running through a zone which is subject to a continuous vacuum, but it would be necessary for the ribbon components entering the zone (and exiting the zone) to pass through some narrow opening which largely prevents air from entering the enclosure, otherwise the effect of the vacuum would be diminished.

For at least some of the intended applications, i.e. those involving refrigerants under pressure, it is desirable to achieve a fully bonded structure, in order to prevent pockets of pressurized refrigerant from forming between the tubes and the film layers. This requires that essentially all of the air between the film layers and the tubes must be removed during the manufacturing process. Instead of the air being withdrawn by a vacuum, the air could be squeezed out by externally applied pressure. It is theoretically possible to achieve this by applying fluid jets to the outside of the ribbon structure.

Another, perhaps more conventional, way of pushing out the air, would be to squeeze the structure between two nip rolls. It is known in the art that film layers can be laminated by nipping them between a metal roll and a rubber roll. The complication here is the non-uniform cross-sectional shape of the ribbon.

A rubber-coated roller, of uniform cross-section, when pressed against the ribbon, does not apply the appropriate pressure at the locations immediately adjacent to a tube. The same is true if a fluid-filled bladder is used as the nip roll.

Before constructing shaped rollers, it was considered prudent to experiment with the squeezing of the ribbon structure between two grooved plates. Initial testing with matching metal plates resulted in samples in which the foil layer was damaged. It also appeared that there was an inability to apply uniform pressure, as the metal plates were quite rigid.

Better results were obtained when a matching set of grooved plates, one of which was metal and the other was rubber, backed by metal, were used to clamp the film layers and tubes together. Furthermore, configurations in which both plates have metal interface offer superior results, so long as these plates are precisely machined to tolerances that promote a closely coordinated matching of plate surfaces. It is possible, under the right conditions, to squeeze out all of the air between the tubes and the film layers and fully bond the layers together without tearing the metallic layer and without generating many wrinkles.

The next step was to construct a grooved rubber nip roll and press it against the ribbon which lay in a series of grooves in a metal plate, with the metal plate being heated in order to form a melt-bond between the layers. An initial demonstration of the feasibility of this approach has been made. A continuous process has also been demonstrated, in which a single tube structure was squeezed and bonded between a grooved, PTFE coated, heated metal plate and a grooved, rubber nip roll. A set of rollers may also be coordinated to press the foils around the tubes.

There are a number of potential variations and improvements on this basic approach.

a) There may not need to be any direct squeezing of the tubes. The outer surface of the roller or plate, in pushing the film down into the gap between adjacent tubes, may tend to pull the film tight over the tube. Thus, it may not be necessary to contour the grooves to match the circular shape of the tubes. It may be desirable not to squeeze too hard on the plastic tubing, as it may distort or even collapse under excessive pressure, especially if hot.

b) One roller or plate could have shaped grooves which contact the ribbon and the other could have the deep grooves described under item (a) above.

c) The hardness or thickness of the material used to promote contact may be varied.

One concern is in tracking the film into a structure of narrower width, since the width of the film is narrower after the film has been fully conformed to the tubes.

There are some possible approaches for dealing with this.

a) It may be possible to track the film into the grooves in the roller by contacting the film to the roller prior to the nip point.

b) The film temperature could be raised to some intermediate temperature (below the melting point) just prior to the squeezing process, to make the film more conformable by lowering the flexural modulus.

c) The film layers and tubes could be contacted between a first set of grooved rollers (or plates) which squeeze out the air and conform the film around the tubes, followed by a second set of rollers (or plates) that apply heat and bond the structure together.

d) The film layers and tubes could be contacted between a first set of grooved heated rollers (or plates) which tack the tubes in position on the film layers, followed by a second set of grooved, heated rollers (or plates), in which the grooves are closer together, which completes the squeezing and bonding of the structure.

In pursuing the approach described in (d) above, some practical difficulties were encountered in tracking the films and tubes between the two sets of grooved plates with different groove to groove spacings. To alleviate this issue, a set of plates was constructed with converging grooves. The converging grooves were of the same size but were spaced closer together at the exit end than they were at the entrance end of the plates. The use of plates with converging grooves resulted in a successful alternative process which is described in Example 3 and illustrated in FIGS. 4 (a)-(c).

In accordance with the above,

i) the film and tubes could all be brought together and squeezed, then heated, and/or

ii) they could be gently squeezed and heated, then further squeezed and heated (with grooves closer together).

It will be understood by those having skill in the art to which the invention pertains, that various methods may be used to appy heat either directly or indirectly and to make the thermal lamination.

In the alternatives given above, the tubes and film are thermally bonded together as a lamination, in which the outer layer of the tubing is melt-bonded to the inner layer of the film. A somewhat related process would be an extrusion lamination, where a molten polymer is applied to (for example) the two film surfaces and then the structure is nipped together.

Another alternative would be to use a thermoset adhesive to bond the tubing to the film layers, an additional station would be added to coat the layers with the thermoset. A nipping operation would still be required, and in some cases heat would be beneficial, but the amount of heat required vs. the thermal lamination approach would be lower.

This invention will become better understood upon having reference to the following examples herein.

### EXAMPLES

### Example 1

Tubing with an inside diameter of 1.64 mm (0.065 inches) and a wall thickness of 0.18 mm (0.007 inches) and made from polyamide 66 resin, was used to make a ribbon structure by bonding the tubing to two film layers. The tubing also contained a heat stabilizer additive, consisting of 0.6 percent of a 7-1-1 (by weight) blend of potassium iodide, cuprous iodide, and aluminum stearate. The tubing (10 ends) was unwound from spools, passed through a tube guide and then through a PTFE jig. The PTFE jig had 10 slots in it, which were parallel, coplanar, and uniformly spaced 7.0 mm (0.274 inches) apart (center to center). The nylon tubing was pulled through the jig, and at the same time, was in contact with a film which was heated from below by a hot plate. The hot plate was a “Dataplate Digital Hot Plate” made by Cole-Parmer and its surface was maintained at a uniform temperature of about 125° C. The film was Marvelseal 360 from Ludlow and was 127 mm (5 inches) wide and 0.132 mm (0.0052 inches) thick, consisting, in order, of about 0.076 mm (0.003 inches) of low density polyethylene (LDPE), 0.0076 mm (0.0003 inches) of aluminum foil, 0.033 mm (0.0013 inches) of LDPE and 0.152 mm (0.006 inches) of polyamide 6. The polyamide 6 layer of the film was in contact with the hot plate and the 0.076 mm (0.003 inches) LDPE layer was facing (and in contact with) the tubes. The heat from the hot plate partially melted the LDPE layer and bonded the tubes to the film at their tangent points. The film and tubes were pulled at a uniform speed of 152 cm (5 feet) per minute with a Killion model 4-24 belt puller and cut into 610 cm (20 feet) lengths.

The film with the attached parallel tubes was then placed facing a second layer of film with the LDPE sides facing each other and the parallel edges of the two films were heat sealed together using a DOBOY “Hospital Sealer” (a continuous/rotary heat sealer). Lengths of this sleeve were produced which were approximately 610 cm (20 feet) long and 127 mm (5 inches) wide. Short lengths of tubing were peeled back and cut off at each end, so that the film extended past the tubing at each end, in order to allow the next step to proceed.

The sleeves thus formed were then coiled up and placed, one at a time, in an AUDIONVAC AE401 vacuum sealer such that both film ends were laid across the heat seal bar. The chamber was evacuated for one minute and then the ends were heat sealed. This resulted in a sleeve in which the film conformed to the shape of the tubes, since substantially all of the air had been removed from inside the sleeve.

The vacuum-sealed sleeves were then placed, one at a time in a Blue M oven (model OV-490A-3) and heated at 120° C. for 10 minutes. The heat melted the LDPE and bonded the structure together. After the ribbons cooled, the excess edges were slit off, to within about 3 mm (⅛ inch), of the edge of the first tube on each side. The ends were also cut and slit between the tubes to facilitate the end-joining.

Four pieces of ribbon were wound on a circular plastic core of approximately 86 mm (3⅜ inches) OD with their ends passing through slots in the core. They were interwound to make a circular coil with a final diameter of 15 mm (10 inches). The total amount of ribbon wound on the core was approximately 15 m (50 feet), with some additional length for end connections. Each alternating layer of ribbon was staggered or offset from the previous layer in such a way as to create a pathway for air to pass through the coil between the ribbon layers. The ribbons were held by means of plastic spacers, made from glass fiber reinforced polyamide 66 resin, which were threaded onto 12 metal guideposts projecting from the plastic core. The spacers had grooves machined in them which held the ribbons in place. The spacing between layers in the coil was 2.9 mm (0.115 inches), measured as the centerline to centerline distance.

End connections were made by trimming excess film from the ends of the ribbon and then melt-bonding the tube ends into holes in a small, circular polyamide 66 tubesheet using hot pins, as taught in U.S. Pat. No. 6,001,291, granted Dec. 14, 1999. This tubesheet was then held in a larger assembly which served to connect it to a metal header joint, with the seal being provided by an O-ring.

The circulating chlorodifluoromethane (R22) refrigerant was passed through an external mass flow meter, which was in line with the standard components (compressor, condenser, expansion device) of the air conditioner, as well as the new evaporator. When this unit was operated, the refrigerant flow rate was measured to be 0.73 kg/min (1.6 lb/min), the refrigerant liquid stream (prior to entering the expansion device) was at 48.9° C. (120° F.) and the refrigerant exiting the evaporator was 2.2° C. (36° F.) and was entirely vapor. The air conditioner was connected to a mass flow meter for the refrigerant (R22) and was subjected to a wind tunnel performance test.

During operation, air was blowing through the evaporator coil, being driven by the standard fan incorporated in the air conditioner. The heat duty, which is the amount of heat transferred from the air to the refrigerant stream, per unit of time, was 1747 Watts (99.4 Btu/min).

The air temperatures were 35.8° C. (96.4° F.) entering the evaporator and 13.1° C. (55.6° F.) exiting the evaporator, with an air flow rate of 1.83 kg/min (4.04 lb/min). The amount of moisture condensed from the air stream was not measured. While the heat duty was less than the nameplate capacity, it should also be considered that the experimental coil only occupied a fraction of the available area. The rate of heat transfer, on a per unit of volume basis, or on a per unit of facial area basis, was actually slightly higher for the experimental coil, than it was for the original evaporator.

### Example 2

Tubing with an inside diameter of 1.60 mm (0.063 inches) and a wall thickness of 0.20 mm (0.008 inches) was used to make a ribbon structure by bonding the tubing to two film layers. The tubing was a coextruded structure in which the inner layer consisted of nylon 66 at 0.165 mm (0.0065 inches) thick and the outer layer consisted of an anhydride-modified low density polyethylene 0.038 mm (0.0015 inches) thick, available from E. I. DuPont de Nemours & Co. as Bynel® 4206. The melting point of the polymer in the outer layer was approximately 102° C., its melt index was 2.5 and its density was 0.92 g/cc. The purpose of the outer layer was to improve the bond between the tubing and the film in the finished ribbon structure. The nylon 66 inner layer contained a heat stabilizer additive, consisting of 0.6 percent of a 7-1-1 (by weight) blend of potassium iodide, cuprous iodide, and aluminum stearate.

A ribbon structure was prepared as in Example 1. The heat from the oven melted the outer layer of the tubing and the inner layer of the film and bonded the structure together. After the ribbons cooled, the excess edges were slit off, to within about 3 mm (⅛ inches), of the edge of the first tube on each side. The ends were also cut and slit between the tubes to facilitate the end-joining.

Six pieces of ribbon were wound on an elliptical core of approximately 102 mm (4 inches) by 229 mm (9 inches) with their ends passing through slots in the core. They were inter-wound to make an elliptical coil of 381 mm (15 inches) by 254 mm (10 inches). The total amount of ribbon wound on the core was approximately 19 m (63 feet), with some additional length for end connections. Each alternating layer of ribbon was staggered or offset from the previous layer in such a way as to create a pathway for air to pass through the coil between the ribbon layers. The ribbons were held by means of plastic spacers, made from glass fiber reinforced polyamide 66 resin, which were threaded onto 12 metal guideposts projecting from the plastic core. The spacers had grooves machined in them which held the ribbons in place. The spacing between layers in the coil was 2.9 mm (0.115 inches), measured as the centerline to centerline distance.

End connections were made by trimming excess film from the ends of the ribbon and then melt-bonding the tube ends into holes in a small, circular polyamide 66 tubesheet using hot pins, as taught in U.S. Pat. No. 6,001,291, granted Dec. 14, 1999. This tubesheet was then held in a larger assembly which served to connect it to a metal header joint, with the seal being provided by an O-ring.

### Example 3

Tubing with an inside diameter of 1.55 mm (0.061 inches) and a wall thickness of 0.23 mm (0.009 inches) was used to make a ribbon structure by bonding the tubing to two film layers. The tubing was a co-extruded structure in which the inner layer consisted of nylon 66 at 0.19 mm (0.0075 inches thick) and the outer layer consisted of an anhydride-modified low density polyethylene 0.04 mm (0.0015 inches) thick, available from E. I. DuPont de Nemours & Co. as Bynel® 4206. The melting point of the polymer in the outer layer was approximately 102° C., its melt index was 2.5 and its density was 0.92 g/cc. The purpose of the outer layer was to improve the bond between the tubing and the film in the finished ribbon structure. Ten tubes of the above composition were simultaneously bonded to two layers of BFW-48 film from Ludlow Corporation. The BFW-48 film consists of (in order) approximately 0.038 mm (0.0015 inches) of LLDPE (linear low density polyethylene), 0.022 mm (0.00085 inches) of LDPE (low density polyethylene), 0.007 mm (0.00029 inches) of aluminum foil, 0.022 mm (0.00085 inches) of LDPE and 0.012 mm (0.00048 inches) of PET (polyethylene terephthalate), for a total thickness of approximately 0.10 mm (0.004 inches).

The 10 tubes and 2 films were pulled between a pair of grooved aluminum plates, approximately 178 mm (7 inches) long Each plate had 10 semicircular grooves running along its length, the width of each groove was 2.3 mm (0.090 inches). The plates faced each other and the order of material position was: bottom plate, bottom film, tubes, top film, top plate. The grooves in the plates were not parallel but they were straight. At the inlet end of the plates the grooves had a (center to center) spacing of 6.52 mm (0.2567 inches) and at the outlet end of the plates the center to center spacing was 5.94 mm (0.2338 inches). The plates were heated and maintained at a temperature of 145° C. A weight of 5 kg (11 pounds) was on top of the top plate, in order to provide pressure. The heat melted the polyethylene layers on the tubing and the film, causing them to bond together.

The films and tubes then passed through a matching set of grooved plates, similar to the above, except that the grooves were parallel and were 5.94 mm (0.2338 inches) apart (center to center) along their entire length. The cooling plates were in contact with hollow metal plates through which cooling water (of inlet temperature 12° C.) was circulated at 2 litres per minute. A small weight of 3.5 kg (7.7 pounds) was located on the uppermost plate in order to press on the materials passing through the plates. All 4 of the grooved plates were covered with PTFE (approximately 0.003 inches thick) in order to minimize friction. The film and tubes were pulled at a uniform speed of 21 cm (0.7 feet) per minute with a Killion model 4-24 belt puller and the edges were trimmed. The resulting structure was a ribbon which had fewer wrinkles than the samples made by Examples 1 and 2, and which could be made in very long lengths, limited only by the size of the film supply rolls and tubing supply spools.

What is claimed is:

1. A method for making a fluid handling apparatus comprising a plurality of polymeric tubes arranged in parallel and placed at least 1½ tube diameters apart measured center-to-center, said tubes being surrounded by and sealed to a laminated foil, said foil having two faces, one facing toward the tubes, and the other facing away from the tubes, said foil comprising at least one layer of metal with at least one polymer layer on at least the side facing the tubes,
said tubes having an inner diameter in the range of 0.5-4 mm and a wall thickness in the range of 0.05-0.3 mm,
said foil having a total thickness in the range of 0.05-0.25 mm and a metal thickness in the range of 0.002-0.1 mm,
said method comprising the steps of
contacting the tubes on one side with a first foil, contacting the tubes on the other side of the tubes with a second foil,
heating the tubes with the foil on at least one side to adhere the foil to the tubes before or after contacting the tubes with said second foil,
conforming said first and second foils to the tubes to essentially eliminate air bubbles or gaps,
and optionally completing the heat sealing of both the first and second foils to the tubes with a second heating step.

2. The method of claim 1 wherein the conforming of the foils to the tubes is done by vacuum.

3. The method of claim 1 wherein the conforming of the foils to the tubes is done by sliding the tubes and foils through matching grooves in plates on both sides of the tubes.

4. The method of claim 1 wherein the conforming of the foils to the tubes is done by pressing the foils against each other in regions exterior to the tubes.

5. The method of claim 1 wherein the conforming of the foils to the tubes is done by rollers pressing the foils around the tubes.

6. The method of claim 1 wherein the tubes and laminated foil are flexible.

7. The method of claim 1 wherein said tubes further comprise a plurality of layers of polymer.

8. The method of claim 1 wherein the polymer of at least one layer of the foil facing away from the tubes is polyamide.

9. The method of claim 7 wherein the tubes interface with and are thermally bondable to the polymer layer of the foil on the side facing the tubes.

10. The method of claim 9 wherein at least one layer of the tubes and at least one layer of the polymer of the foil are both polyamide.

11. The method of claim 1 wherein the thickness of foil is in the range of 0.07-0.2 mm and the thickness of the metal is in the range of 0.005-0.02 mm.

12. The method of claim 11 wherein the thickness of the foil is in the range of 0.1-0.15 mm and the thickness of the metal is in the range of 0.005-0.01 mm.

13. The method of claim 1 wherein the inner diameter of the tubes is in the range of 1-3 mm and the wall thickness of the tubes is in the range of 0.1-0.25 mm.

14. The method of claim 1 wherein the metal is aluminum.

15. The method of claim 1 wherein the foil has a layer of polyolefin on the side facing the tubes.

16. The method of claim 1 wherein the foil has no layer of polymer on the side facing away from the tubes.

17. The method of claim 1 wherein there are multiple layers of polymer in the foil.

18. A structure made by the process of claim 1 wherein there are no significant air gaps or voids between the foil and the tubes.

19. The method of claim 1 wherein the first heating step is applied after the first foil is contacted with the tubes and before the second foil is contacted with the tubes, and wherein the second heating step is used.

20. The method of claim 1 wherein the first heating step is applied after both the first and second foils are contacted with the tubes, and the second heating step is not used.

21. The method of claim 1 wherein the first heating step is applied after both the first and second foils are contacted with the tubes, and at least one more heating step is used.
